(19) United States
(12) Patent Application Publication
(10) Pub. No.: US 2005/0128430 A1
(43) Pub. Date: Jun. 16, 2005

(54) Eye glass clip

(76) Inventor: Michael Uren, Anaheim, CA (US)

Correspondence Address: US CORPORATIONS, INC., 630 NEPTUNE AVE., ENCINITAS, CA, 92024, US

(21) Appl. No.: 10/959,936

(22) Filed: Oct. 6, 2004

Related U.S. Application Data
(60) Provisional application No. 60/511,227, filed on Oct. 15, 2003.

(51) Int. Cl. G02C 5/14

(52) U.S. Cl. 351/112

(57) ABSTRACT

A hidden device for holding sunglass, eyeglasses or the like, to clothing is disclosed. The inventive device includes a holding clip and release button manufactured within the frame of the glasses in a location advantageous for proper weight distribution while in a vertical position. A retractable holding clip extends from the frame of the glasses when activated allowing for secure stowage while attached to ones apparel.

### CROSS-REFERENCE TO RELATED APPLICATION

60511227

### STATEMENT REGARDING FEDERALLY SPONSORED RESEARCH OR DEVELOPMENT

Not applicable

### REFERENCE TO SEQUENCE LISTING

Not applicable

### FIELD OF INVENTION

This invention relates to sunglasses and eye wear of the like, specifically to a clip accessory or addition that will permit the eyeglass owner to secure the eyeglasses, when not in use, in a shirt pocket, belt or anywhere on a garment with the use of a hidden clip.

### BACKGROUND OF THE INVENTION

In the case there is no convenient place to lay the glasses when not in use; a wearer will often try to stick them in a pocket or the like. The glasses tend to fall out of the pocket and break or get stepped on. Therefore, there is a need for a device to secure eye glasses to the clothing of a wearer.

While some people wear glasses constantly, others wear them only intermittently or change from clear to tinted glasses depending on the ambient light conditions. It is desirable to have a clip attached to a temple bar of the glasses to engage the edge of a garment, such as a shirt pocket or belt, thereby preventing the folded glasses from falling out when bending over. Many attempts at the ideal design and method of this clip have been made over the years. Some involve modification of the temple bar or permanent attachment of the clip to the temple bar at the time of manufacture. Other attachable clips are cumbersome to mount, alter the appearance of the glasses substantially, involve expensive manufacture, provide non rigid attachment, or are conformable to a limited range of temple piece cross sections.

### DISCUSSION OF PRIOR ART

Temple bar clips discussed are disclosed in U.S. Pat. No. 4,903,375, issued Feb. 27, 1990, to Di Franco; U.S. Pat. No. 1,973,648, issued Sep. 11, 1934, to Nagel; U.S. Pat. No. 1,898,059, issued Feb. 21, 1933 to McDonald; U.S. Pat. No. 1,787,830, issued Mar. 11, 1930, to Marvin; and U.S. Pat. No. 1,779,015, issued Oct. 21, 1930, to Schmitt. All of the above mentioned temple bar clips use a flat spring clip. The notable difference between them is the method by which the clip is attached and located on the eyeglass temple bar.

Schmitt uses rivets to attach the clip directly, an operation best performed during manufacture of the temple bar. Installation on an existing pair of eyeglasses requires tools and special skills. Once installed, the clip is easily visible.

Nagel fixes a clip to a metal sheath member that applies spring force to a flexible tubular member that is inserted over the temple bar.

McDonald attaches a clip with a sleeve and set screw and Marvin uses an interference fit. The clips of McDonald, Marvin and Nagel are not practical today because of the variety of sizes and shapes of temple bars.

DiFranco attaches a plastic clip using O-rings of various sizes

(a). The plastic clip of DiFranco's preferred embodiments can easily be over-stressed and broken, especially when used on a garment with thicker pocket rim material such as a flannel shirt or the like. In contrast, the metal compression spring used in the clip of the present invention results in a more durable, versatile product.

(b). On some eyeglass designs, the ear portion of the temple bar is much larger than the portion near the hinge. Because of this, the O-rings taught by DiFranco could easily be stretched beyond their elastic limit while being slipped over the larger ear portion, making them too large to properly fit the temple bar near the hinge, rendering the clip useless. O-rings are generally made for creating seals in compression and are not intended to be used in tension as a structural member. In contrast, an elastic band such as that used in the present invention is created for applications in which it can recover from stretching operations.

(c). Skin oil can be transferred to the temple bar in the proximity of the clip and O-rings. This oil could substantially reduce the friction that the O-rings can impart to the temple bar and may cause the clip to slide relative to the temple bar. In contrast, the attachment band of the present invention has a relatively large inside surface area away from the end openings and thereby that area is protected from such oil exposure.

### SUMMARY OF THE INVENTION

It is an object of this invention to provide an eyeglass storage clip being hidden within the frame of the glasses having a spring clip to allow secure storage of eyeglasses in a pocket or anywhere on a garment with equal ease.

It is an object of this invention to provide said hidden eyeglass storage clip with a spring clip wherein the actuating button and springs are totally enclosed within the eye glass body thereby to preventing the wearer from tearing the clip off by accident.

It is an object of this invention to provide said eyeglass storage clip having a hidden attachment clip.

It is an object of this invention to provide a hidden eyeglass storage clip having a spring clip with adequate strength to permit secure storage when not in use.

It is further an object of this invention to be easily and inexpensively manufactured from commercially available components and materials.

Further objects and advantages will become apparent from a consideration of the ensuing description and drawings.

Thus, it is an object of the invention to provide an improved eye glass clip device construction.

A further object of the invention is to provide an eye glass clip device construction which is rugged, economical, easily adjusted to accommodate various girths and various combinations of apparel materials.

Another object of the invention is to provide an improved eye glass clip which includes a release button located on the outside of the earpiece which is shaped to blend with the eye glass design.

Accordingly, it is an object of the present invention to provide an eye glass clip which embodies a self retracting holding clip.

Further still, it is an object to provide such an eye glass clip which will hold the glasses in place on the shirt or jacket even when inverted.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new eye glass clip apparatus and which has many of the advantages of the devices mentioned heretofore and many novel features that result in an eye glass clip which is not anticipated, rendered obvious, suggested, or even implied by any of the prior art tool guides, either alone or in any combination thereof.

It is another object of the present invention to provide a new eye glass clip which may be easily and efficiently manufactured and marketed.

It is a further object of the present invention to provide a new eye glass clip which is of a durable and reliable construction.

An even further object of the present invention is to provide a new eye glass clip which is susceptible of a low cost of manufacture with regard to both materials and labor, and which accordingly is then susceptible of low prices of sale to the consuming public, thereby making such eye glasses economically available to the buying public.

Still yet another object of the present invention is to provide a new eye glass clip which provides in the apparatuses and methods of the prior art some of the advantages thereof, while simultaneously overcoming some of the disadvantages normally associated therewith.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### ILLLUSTRATIONS

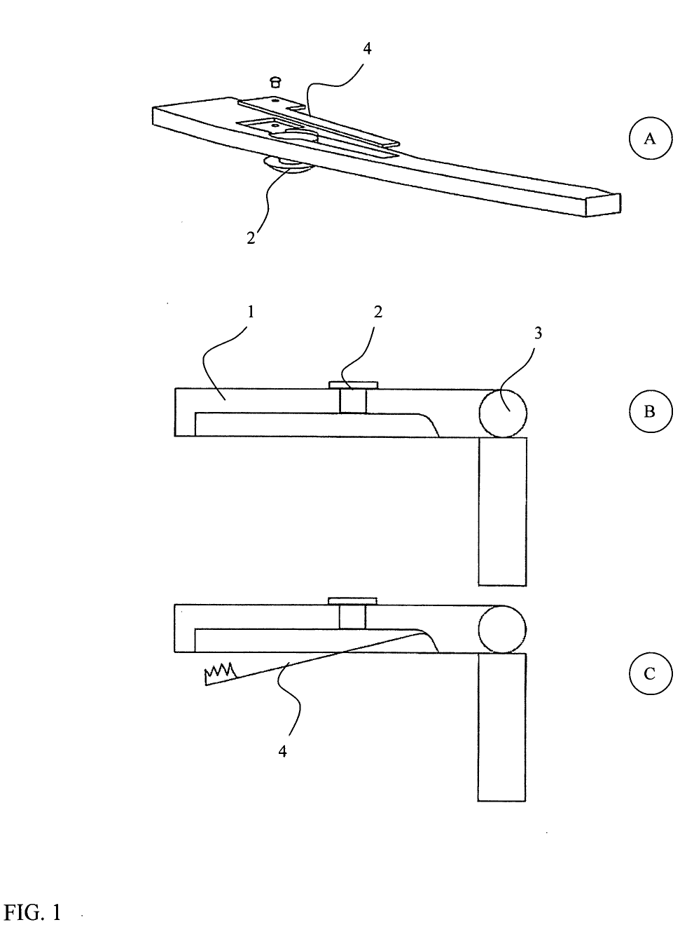

FIG. 1

A perspective view of the top side of the device, clip and release button assembly.

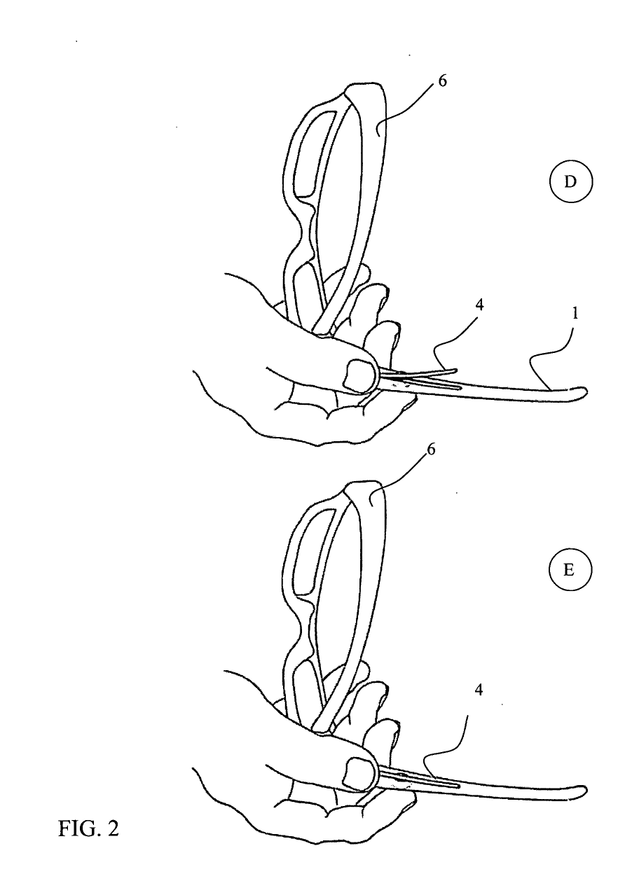

FIG. 2

A perspective view of the bottom and right side of the device, clip and release button, activating and de-activating the device clip.

### DETAILED DESCRIPTION OF THE PREFERRED EMBODIMENT

Referring now to FIG. 1, Illustration A, B and C, the eyeglass clip device of the present invention is used in conjunction with and attached to sunglasses or eyeglasses not completely illustrated in this figure. The eyeglass clip device 4 will be connected to the glasses 1, at one end and released with a release button 2. The glasses can now be hung on a shirt, jacket etc. allowing the glass's hinge 3, to collapse on the clip holding the glasses tightly.

Referring now to FIG. 2, Illustration D and E, the clip 4, is flush mounted and out of sight unless the release button 2, is pushed. Once the release button 2, is pushed, the clip device 4, will toggle outwardly exposing one end used to grasp the clothing or apparel the glasses are to be hung on.

1. An eye glass clip which is permanently fabricated into the temple area of the eye glass frame to prevent them from falling from the neckline or pocket when the glasses are folded and hanging while not in use.

2. An eye glass clip device according to claim 1 wherein the clipping device is hidden within the inside of the temple frame.

3. An eye glass clip device according to claim 1 wherein the device embodies a button which releases one end of the clip allowing full usage.

4. An eye glass clip device according to claim 1 wherein a gripping area of the clip is attached to the inside arm of the clip for gripping the surface of the shirt or jacket.

5. An eye glass clip device according to claim 1 wherein the device can be used for eye glasses or sun glasses.
